(19) United States
(12) Patent Application Publication
(10) Pub. No.: US 2006/0181187 A1
(43) Pub. Date: Aug. 17, 2006

(54) Spacer for flat panel display and flat panel display

(75) Inventors: Mio Hosokawa, Tokyo (JP); Yukio Kawaguchi, Tokyo (JP); Atsushi Hitomi, Tokyo (JP); Keiko Kubo, Tokyo (JP); Emi Ninomiya, Tokyo (JP); Hiroaki Sawada, Tokyo (JP)

Correspondence Address: HOGAN & HARTSON L.L.P., 500 S. GRAND AVENUE, SUITE 1900, LOS ANGELES, CA, 90071-2611, US

(73) Assignee: TDK Corporation

(21) Appl. No.: 11/354,228

(22) Filed: Feb. 14, 2006

(30) Foreign Application Priority Data
Feb. 17, 2005 (JP) 2005-041128

(51) Int. Cl. H01J 19/42; H01J 1/88; H01K 1/18

(52) U.S. Cl. 313/292

(57) ABSTRACT

A spacer for a flat panel display having a coefficient of thermal expansion equal or close to that of a glass and having a strength and a predetermined conductivity is provided. The spacer for a flat panel display includes a sintered body containing MgAl₂O₄ preferably as a main phase. The sintered body preferably further contains MgO, and if it contains MgAl₂O₄ and MgO, a peak strength on a MgO (200) surface is preferably 0.5 to 50 when a peak strength on a MgAl₂O₄ (311) surface is 100 as measured by X-ray diffraction. The spacer is placed between a back plate having a cathode structure and a face plate placed with a predetermined spacing between itself and the back plate and having fluorescent pixel areas, and plays a role of maintaining the spacing.

### BACKGROUND OF THE INVENTION

1. Field of the Invention

The present invention relates to a spacer for a flat panel display and a flat panel display.

2. Description of the Related Art

Thin and light flat displays are known as displays alternative to bulky and heavy Braun tubes. Field emission displays (FED) are known as one type of flat displays. The FED is a self-luminous flat display applying a conventional cathode ray tube (CRT), and its principle of display of images is similar to that of the Braun tube. The FED comprises a cathode structure having a large number of cathodes (field emission elements) arranged in a two-dimensional form, in which electrons emitted from the cathodes under an environment of reduced pressure (e.g. 10-5 Torr or less) are accelerated and collided against targeted fluorescent pixel areas to form a luminous image (Japanese Patent Laid-Open No. 2001-68042 (Patent Document 1)).

The FED comprises two flat glass base plates: a back plate comprising a cathode structure emitting electrons and a face plate comprising fluorescent pixel areas, and the width of a space between the two glass base plates is approximately 0.1 to 3 mm. The space between the two glass base plates is kept at a reduced pressure of, for example, 10⁻⁵ Torr or less as described above, and therefore the surfaces of the two glass base plates are exposed to atmospheric pressure. Thus, a pressure resistant structure (hereinafter referred to spacer) to counter atmospheric pressure is placed between the two glass base plates so that the space between the two glass base plates is maintained (Patent Document 1).

There exist several types of spacers, and one of them is a strip spacer. The strip spacer is positioned perpendicularly between the face plate and back plate. The spacer is positioned between fluorescent pixels. The spacer is required to have a strength sufficient to endure a strong compressive force received from the face plate and the back plate. Further, a high level of dimensional accuracy is required for each spacer. Since a high voltage of, for example, 1 kV or greater is applied to between the face plate and the back plate, the spacer is required to have a resistance to a high voltage and a conductivity for preventing electrification.

As this spacer, Japanese Patent No. 3340440 (Patent Document 2) discloses ceramics in which a transition metal oxide is dispersed. In Patent Document 2, alumina is proposed as the ceramics, and titania, chromia, iron oxide and vanadium oxide are proposed as transition metal oxides.

Japanese Patent Laid-Open No. 2004-111337 (Patent Document 3) discloses ceramics containing at least one of SiC and B₄C, Al₂O₃ and TiC.

Japanese Patent Laid-Open No. 2004-349178 (Patent Document 4) discloses ceramics containing Al₂O₃, TiC and TiO₂.
[Patent Document 1] Japanese Patent Laid-Open No. 2001-68042
[Patent Document 2] Japanese Patent No. 3340440
[Patent Document 3] Japanese Patent Laid-Open No. 2004-111337
[Patent Document 4] Japanese Patent Laid-Open No. 2004-349178

Compared with the ceramics disclosed in Patent Document 2 in which a transition metal oxide is dispersed, the ceramics disclosed in Patent Document 3 and Patent Document 4 have an advantage that the ceramics shows a nature of AlTiC which is a high-hardness conductive ceramics because it contains TiC and Al₂O₃, thus is resistant to deformation by a compressive force, and is hard to be electrically charged because it has a predetermined conductivity, so that distortion and the like of images can be reduced when the ceramics is used as a spacer for a flat panel display.

As a characteristic required as that of the spacer for flat panel display, its coefficient of thermal expansion should be close or equal to the coefficient of thermal expansions of the face plate and the back plate composed of a glass. This is because if a change in temperature occurs in a range of −30 to 50° C. which is a range of temperature tolerated by the display during image display, the spacer shifts out of place due to occurrence of a thermal stress, and emitted electrons are deflected, leading to occurrence of visible defects on the display.

Namely, the thermal expansion efficient of Al₂O₃ is 6.2×10⁻⁶/° C. (0 to 300° C.), and shows a considerable difference compared to the coefficient of thermal expansion of the glass constituting the face plate and the back plate: 8.0 to 9.3×10⁻⁶/° C., and therefore a spacer for a flat panel display sufficiently coping with a change in temperature cannot be provided with ceramics containing Al₂O₃. For example, the coefficient of thermal expansion of the sintered body disclosed specifically in Patent Document 3 is 6.9 to 7.3⁻⁶/° C.

The present invention has been made in view of the technical problems described above, and its object is to provide a spacer for a flat panel display having a coefficient of thermal expansion close or equal to that of a glass compared to Al₂O₃. In addition, an object of the present invention is to provide a flat panel display using the spacer for a flat panel display.

### SUMMARY OF THE INVENTION

For functioning as a spacer for a flat panel display, it is necessary to have not only a coefficient of thermal expansion close or equal to that of a glass but also a strength and a predetermined conductivity. The inventor has found that MgAl₂O₄ is effective as a material having these characteristics as a result of various studies. Namely, the present invention is a spacer for a flat panel display comprising a sintered body containing MgAl₂O₄. In the present invention, MgAl₂O₄ preferably constitutes a main phase of the sintered body.

The sintered body of the present invention may contain MgO in addition to MgAl₂O₄. If the sintered body of the present invention contains MgAl₂O₄ and MgO, a peak strength on a MgO periclase (200) plane is preferably 0.2 to 50 when a peak strength on a MgAl₂O₄ spinel (311) plane is 100 as measured by X-ray diffraction.

The sintered body of the present invention preferably contains a conductive compound in addition to MgAl₂O₄ for functioning as a spacer for a flat panel display. The conductive compound is preferably a titanium compound, and the titanium compound is preferably at least one of carbides, nitrides, oxides and carbonitrides of Ti.

The present invention also provides a flat panel display comprising a back plate having cathode structure, a face plate placed with a predetermined spacing between itself and the back plate and having fluorescent pixel areas, and a spacer placed between the back plate and the face plate and holding the spacing, wherein the spacer comprises a sintered body containing MgAl₂O₄.

As described above, according to the present invention, a spacer for a flat panel display having a coefficient of thermal expansion close or equal to that of a glass can be obtained because the spacer comprises a sintered body containing MgAl₂O₄ as a main phase. The spacer can have a strength and a predetermined conductivity. Thus, a flat panel display using the spacer can reduce distortion of images.

### BRIEF DESCRIPTION OF THE DRAWINGS

FIG. 1 is a partially broken plan view of an FED;

FIG. 2 is a cross-sectional view of a part shown by the arrow II-II in FIG. 1;

FIG. 3 is a perspective view showing a spacer;

FIG. 4 is a view of a part shown by the arrows IV-IV in FIG. 1;

FIG. 5 is a chart showing the results of X-ray diffraction of sample No. 2 of example 1; and

FIG. 6 is a chart showing the results of X-ray diffraction of sample No. 15 of example 2.

FIG. 7 shows SEM images of the sample No. 28 (with no Cr added) and the sample No. 31 (with Cr added) of example 3.

### DETAILED DESCRIPTION OF THE PREFERRED EMBODIMENTS

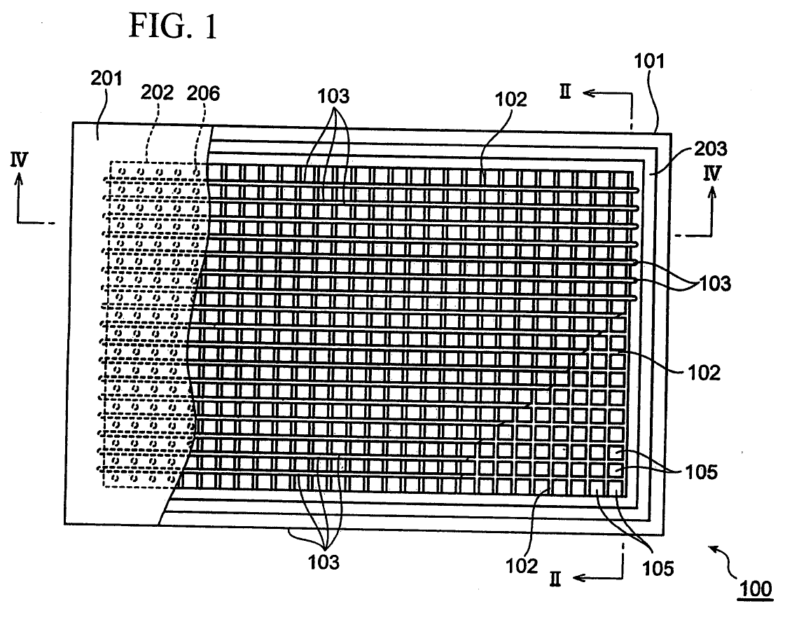

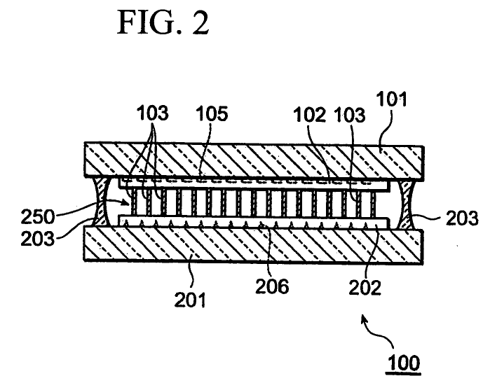

First, an FED and an FED spacer, to which the present invention is applied, will be described in reference to an embodiment. FIG. 1 is a partially broken plan view of the FED and FIG. 2 is a cross-sectional view of a part shown by the arrow II-II in FIG. 1.

In FIGS. 1 and 2, an FED (field emission display) 100 comprises a face plate 101 made of glass, and a back plate 201 placed at a predetermined space from the face plate 101, and a plurality of spacers 103 makes equal the space between the face plate 101 and the back plate 201.

A black matrix structure 102 is formed on the face plate 101 made of glass. The black matrix structure 102 includes a plurality of fluorescent pixel areas 105 composed of phosphorous layers. The fluorescent pixel areas 105 emit light to form a visible display when high energy electrons collides the phosphorous layer. Light emitted from a specific fluorescent pixel area 105 is made to outgo via the black matrix structure 102. The black matrix structure 102 is a lattice black structure for inhibiting mixture of light from mutually neighboring fluorescent pixel areas 105. As a glass material constituting the face plate 101, for example, a strengthened glass or chemically strengthened glass may be used. The coefficient of thermal expansion of such a glass material is approximately 8.0 to 9.3×10⁻⁶/° C. The same holds true for a back plate 201 described later.

On the face plate 101, the back plate 201 is placed via spacers 103 constituting a wall suspended from the surface of the face plate 101. A cathode structure 202 is formed on a surface of the back plate 201 made of a glass, which faces the face plate 101. The cathode structure 202 has a plurality of cathodes (field (electron) emission elements) 206 that includes a plurality of raised portions for emitting electrons.

The area on which the cathode structure 202 is formed is smaller than the area of the back plate 201. A glass seal 203 formed by, for example, a molten glass frit exists between the outer periphery of the face plate 101 and the outer periphery of the back plate 201, whereby a sealed chamber 250 is formed at the center. The interior of the sealed chamber 250 is decompressed to the extent that electrons can travel in air. The cathode structure 202, the black matrix structure 102 and the spacers 103 will be placed in the sealed chamber 250.

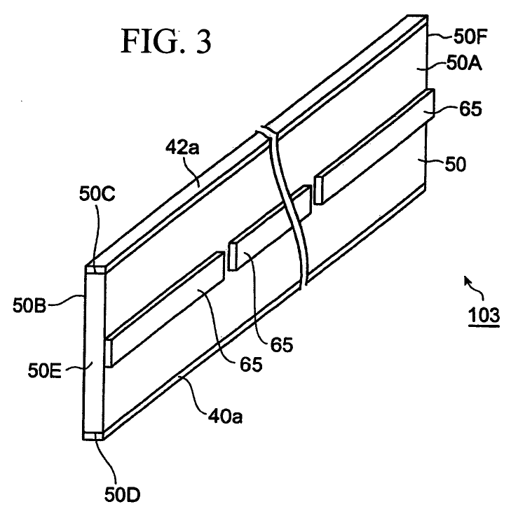

A perspective view of the spacer 103 is shown in FIG. 3. The spacer 103 has main surfaces 50A and 50B being front and back surfaces of a base 50, side faces 50C and 50D extending along the longer direction, and edge faces 50E and 50F at both ends in the longer direction. A patterned metal film 65 is formed on the main surface 50A, and metal films 42a and 40a are formed on the side faces 50C and 50D, respectively. The metal film 65 is divided into a plurality of sections and extends along the longer direction of the spacer 103. The metal film 65 is kept separated from the metal films 42a and 40a to the extent that insulation can be provided therebetween. The size of the base 50 of the spacer 103 is specifically, for example, approximately 0.08 mm×1.2 mm×120 mm.

Metal films 40a and 42a of the spacer 103 are formed for ensuring the in-plane uniformity of a contact resistance with the cathode structure 202 of the back plate 201 and the black matrix structure 102 of the face plate 101. A metal film 65 is formed for making suitable an internal electric filed distribution of the spacer 103.

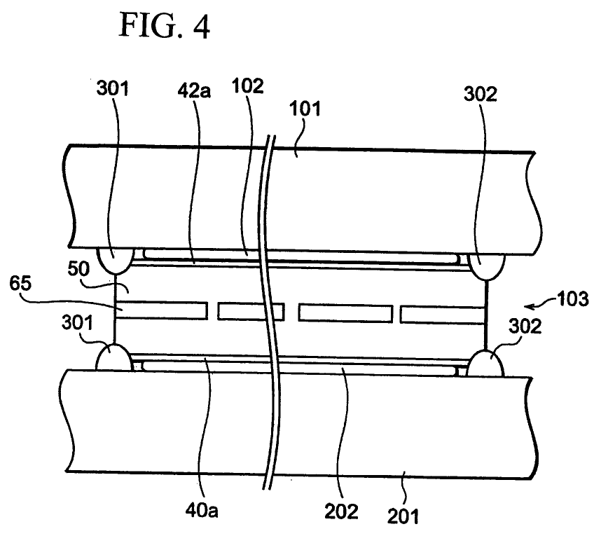

FIG. 4 is a view of a part shown by the arrow IV-IV in FIG. 1. As shown in FIG. 4, the spacer 103 is fixed to the face plate 101 and the back plate 210 by adhesives 301 and 302 provided along the longer direction. For the adhesives 301 and 302, an ultraviolet curable adhesive, thermoset adhesive or inorganic adhesive may be used. The adhesives 301 and 302 are placed outside the black matrix structure 102 and the cathode structure 202. In this case, the metal films 40a and 42a of the spacer 103 contact the cathode structure 202 of the back plate 201 and the black matrix structure 102 of the face plate 101, respectively.

In the present invention, the spacer 103 is constituted by a sintered body containing MgAl₂O₄. Here, the coefficient of thermal expansion of MgAl₂O₄ is 8.1×10⁻⁶/° C. (40 to 400° C.), which is close or equal to the coefficient of thermal expansion of a glass (8.0 to 9.3×10⁻⁶/° C.) compared to that of Al₂O₃ (6.2×10⁻⁶/° C.) (0 to 300° C.). Thus, the spacer 103 comprising a sintered body containing MgAl₂O₄ can prevent defects of images based on a difference in the coefficient of thermal expansion between the spacer 103 and the face plate 101 and the back plate 201 even if the temperature of an environment in which a FED is used changes. In addition, no excessive distortion and stress is caused by a heat treatment in a panel production step.

The sintered body used in the spacer 103 in the present invention contains MgAl₂O₄ particularly preferably as a main phase. In the present invention, X-ray diffraction (XRD) using a CuKα1 ray is used for identification of the main phase in the sintered body, and a phase showing the highest peak strength in a chart of a diffraction line of 30°≦2θ≦80° is defined as a main phase.

The sintered body used in the spacer 103 in the present invention contains MgAl₂O₄ preferably as a main phase, and may further contain MgO in its microstructure. Because the coefficient of thermal expansion of MgO is 12.1×10⁻⁶/° C. (20 to 300° C.), MgO is advantageous for making the coefficient of thermal expansion as an entire sintered body equal to the coefficient of thermal expansion of a glass (8.0 to 9.3×10⁻⁶/° C.) by adjusting a quantitative ratio to MgAl₂O₄.

If the sintered body of the present invention contains MgAl₂O₄ and MgO, the peak strength on the MgO (200) plane is preferably 0.2 to 50 when the peak strength on MgAl₂O₄ (311) plane is 100 as measured by X-ray diffraction. It is more preferably 1 to 35. This peak strength ratio has a preferable range which varies depending on whether TiC is added or not, as will be understood by referring to examples described later. If TiC is not added, the peak strength is preferably 0.2 to 35, more preferably 1 to 17. If TiC is added, the peak strength is preferably 0.5 to 50, more preferably 5 to 35.

The sintered body of the present invention containing MgAl₂O₄ preferably contains a conductive compound in its structure. The conductive compound adjusts the resistivity of the sintered body to be in the range of 1.0×10⁶ to 1.0×10¹¹Ω·cm, and imparts a suitable conductivity to the sintered body. A titanium compound exhibiting this function and constituting a sintered body with MgAl₂O₄ is preferable for the present invention. The titanium compound is more preferably at least one of carbides, nitrides, oxides and carbonitrides of Ti. However, the present invention does not exclude other conductive compounds. For example, one or more of a carbide, a nitride, an oxide and a carbonitride of Zr, Hf, V, Ta, Nb, W, Mo and Cr may be used. Carbides, nitrides and carbonitrides of the elements including Ti are stable conductive materials, while the oxides become conductive when oxygen vacancy occurs by a reduction treatment, such as sintering under a low oxygen partial pressure.

The sintered body of the present invention containing MgAl₂O₄ as described above constitutes a conductive ceramics having a high hardness (Hv: 15 to 30 GPa) and a high strength (three-point bending strength: 400 to 500 MPa), and can be resistant to deformation by a compressive force during use of a flat display. A resistivity of 1.0×10⁶ to 1.0×10¹¹Ω·cm can be obtained, and therefore even if an electric field is applied, a desired conductivity is shown, electrification is hard to occur, thermal runaway resulting from passage of an overcurrent is inhibited, and distortion of images in the flat panel display can be inhibited. Further, the sintered body can have a coefficient of thermal expansion close or equal to the coefficient of thermal expansion of a glass (8.0 to 9.3×10⁻⁶/° C.). Specifically, the present invention can provide a spacer for a flat panel display, having a coefficient of thermal expansion of 7.7 to 9.6×10⁻⁶/° C., preferably 8.0 to 9.3×10⁻⁶/° C.

The above sintered body containing MgAl₂O₄ preferably as a main phase can be obtained by using a predetermined amount of Al₂O₃ and MgO as a raw material. By using Al₂O₃ and MgO as a raw material, MgAl₂O₄ as a main phase is produced by a solid phase reaction in a sintering process. If a stoichiometric excess of MgO relative to the amount of Al₂O₃ is used as a raw material, MgO exists separately in the structure in addition to MgAl₂O₄. In this case, Al₂O₃ does not exist alone in the structure.

To produce a sintered body containing at least one of carbides, nitrides, oxides and carbonitride of Ti, TiC and/or TiO₂, i.e., either or both of TiC and TiO₂ can be raw materials. Here, if TiC is used as a raw material, materials existing in the sintered body are changed depending on the sintering atmosphere. Thus, when TiC is added, a titanium nitride (TiN) or titanium carbonitride (TiC₍₁₋ₓ₎N₍ₓ)) exists in the sintered body if the sintering is carried out in a nitrogen atmosphere. If the sintering is carried out under vacuum or in an argon atmosphere, or by a hot press using a mold made of carbon, most of TiC as a raw material exists as TiC in the sintered body. A titanium nitride such as TiN may be used as a raw material for the nitride of Ti, and a titanium carbonitride may be used as a raw material for the carbonitride of Ti. If TiO₂ is added as a raw material, TiO₂ is contained in MgAl₂O₄, and cannot be identified by X-ray diffraction. However, in observation by, for example, SEM-EDS, existence of Ti can be confirmed in grains of MgAl₂O₄.

If TiC and TiO₂ are added, it is preferable that TiC is added in an amount range of 2 to 10 wt % and TiO₂ is added in an amount range of 1 to 23 wt %. However, the amount of TiO₂ is preferably adjusted according to whether TiC is contained or not, and is preferably in the range of 1 to 23 wt % if TiC is not contained. If TiC is contained, the amount of TiO₂ is preferably in the range of 1 to 8 wt %.

If the formulation amount of TiC, TiO₂ is not within the range described above, the resistivity may significantly decrease before the field reaches 10000 V/mm.

Further, it may be difficult to obtain a resistivity: 1.0×10⁶ to 1.0×10¹¹Ω·cm, which is suitable as a spacer. If the resistivity is smaller than 1.0×10⁶Ω·cm, an overcurrent may pass, resulting in thermal runaway. If the resistivity is greater than 1.0×10¹¹Ω·cm, charging may tend to occur, resulting in distortion.

Addition of MgO to Al₂O₃produces MgAl₂O₄. For this reason, it is important to add MgO as a raw material for obtaining the spacer of the present invention. If the amount of MgO added increases, MgO which is not consumed for production of MgAl₂O₄ exists alone in the microstructure of the sintered body. As described previously, the coefficient of thermal expansion of MgO is high, i.e. 12.1×10⁻⁶/° C. (20 to 300° C.), and therefore the coefficient of thermal expansion as the entire sintered body increases as the amount of MgO existing alone increases. Thus, in the present invention, the amount of MgO added is preferably 25 to 65 wt %, more preferably 30 to 60 wt %.

Adding a predetermined amount of Cr₂O₃ together with MgO and Al₂O₃ is effective for reducing a secondary electron emission coefficient. By reducing the secondary electron emission coefficient, a flat panel display can be prevented from being electrically charged. The amount of Cr₂O₃ blended for obtaining this effect is preferably 4 wt % or greater, more preferably 6 wt % or greater. However, because the strength decreases as the amount of Cr₂O₃ blended increases, the upper limit of the amount is preferably 15 wt % or less. The amount of Cr₂O₃ blended is preferably 4 to 15 wt %, more preferably 6 to 8 wt %. If Cr₂O₃ is added, a phase of Mg (Al, Cr)₂O₄ can be formed in addition to MgAl₂O₄.

Suitable methods for producing the spacer of the present invention will now be described.

Here, two different production methods will be described. One is a sheet method in which a green sheet is prepared, and then sintered to obtain a spacer. The other is a hot press method in which a sintered body is prepared by a hot press, and then a spacer is cut out from the sintered body. The sheet method will be first described, and the hot press method will be then described.

[Sheet Method]

The sheet method comprises the steps of slurry preparation, sheet formation, binder removal and sintering. Suitable examples for the steps will be described below. The description below is only illustrative.

Slurry Preparing Step

In this step, a slurry for forming a sheet is prepared.

As a raw material powder for a sintered body, a TiC powder and/or a TiO₂ powder, an MgO powder and an Al₂O₃ powder are prepared. The raw material powders are weighed and mixed so as to obtain the composition described above, and then mixed and crushed by a wet process using, for example, a ball mill or the like. The mixing and crushing is continued until the mean particle size becomes approximately 0.1 to 3 μm. The powder mixed and crushed by a wet process is dried to obtain a raw material powder for slurry.

A binder, a dispersant, a plasticizer and a solvent are added to and mixed with the raw material powder for slurry to prepare a slurry for forming a sheet. For the mixing, well known mixing means such as a ball mill may be used. For the binder, a well known binder such as ethyl cellulose, acryl resin or butyral resin may be used. For the dispersant, a sorbitan fatty acid ester or glycerin fatty acid ester may be added. For the plasticizer, dioctyl phthalate, dibutyl phthalate or butyl phthalyl butyl glycolate may be used. For the solvent, a well-known solvent such as terpionel, butyl carbitol or kerosene may be used. By using part of the solvent for slurry for a dispersion media in a step of mixing and crushing the raw material, the slurry can be prepared without drying after the mixing and crushing step. The amounts of binder, dispersant, plasticizer and solvent to be added are not specifically limited, but it is recommended that the amount should be 1 to 10 wt % for the binder, 0.1 to 5 wt % for the dispersant, 0.5 to 10 wt % for the plasticizer, and 20 to 70 wt % for the solvent.

Sheet Forming Step

The slurry obtained as described above is coated on a film such as a polyester film by, for example, the doctor blade method and dried to fabricate a green sheet. The green sheet should have a thickness of approximately 100 to 350 μm. The green sheet may form the green sheet of the aforementioned thickness by stacking a plurality of thin green sheets. The green sheet may be formed as a structure having an ultimately desired width, or may be formed as a structure having a width larger than an ultimately desired width and cut into a wafer (green sheet) having a predetermined width.

Binder Removal Step (Binder Burn-Out Step)

In the binder removal step, the binder contained in the resulting green sheet is removed. In the binder removal step, the green sheet is held at a temperature in the range of 200 to 600° C. for 0.5 to 20 hours. If the heating temperature is less than 200° C. or the holding time is less than 0.5 hours, removal of the binder is insufficient. If the heating temperature is greater than 600° C., oxidation becomes noticeable. If the holding time is longer than 20 hours, removal of the binder is almost completed, and thus an effect matching energy consumption for heating and holding cannot be obtained. Thus, the green sheet is preferably held in a temperature range of 200 to 600° C. for 0.5 to 20 hours for binder removal. The temperature range for binder removal is preferably 300 to 500° C., further preferably 350 to 450° C. The holding time in binder removal is preferably 1 to 15 hours, further preferably 2 to 10 hours.

If TiC is added, the atmosphere in which binder removal is carried out is preferably an atmosphere of a low oxygen partial pressure for preventing decomposition of TiC. For example, it may be an atmosphere with a water vapor introduced into a mixed gas of hydrogen and/or nitrogen. In a sheet method having binder removal as an essential step, a composition containing no TiC, which involves no concern for decomposition of TiC and allows use of an oxidizing atmosphere such as air, is preferably employed.

Sintering Step

The green sheet subjected to the binder removal is then sintered. For sintering, the green sheet should be held in a temperature range of 1400 to 1750° C. If the temperature is less than 1400° C., sintering does not sufficiently proceed, and if the temperature is greater than 1750° C., grain growth advances so far that the strength is reduced. The sintering temperature is preferably 1500 to 1700° C. The heating and holding time in sintering should be appropriately selected from 1 to 12 hours according to the heating and holding temperature. Sintering does not sufficiently proceed if the holding time is less than 1 hour, and it cannot be expected that sintering proceeds farther even if the holding time exceeds 12 hours. The heating and holding time is preferably 2 to 8 hours. Sintering should be carried out in a vacuum or inert atmosphere such as atmosphere of nitrogen gas. The resistivity of the sintered body can be changed by changing the sintering temperature and time. In the above sintering condition, MgAl₂O₄ is produced without problems.

A method for producing a spacer by a sheet method in which a green sheet is prepared and then sintered has been described above, but the spacer of the present invention may be produced not only by this method but also by a hot press method described below.

[Hot Press Method]

The hot press method comprises the steps of granulation, primary compacting and hot press.

Preparation of Granulated Powder

A TiC powder and/or a TiO₂ powder, and a MgO powder and an Al₂O₃ powder are prepared as raw material powders, weighed to a predetermined composition and mixed together in the same manner as in the sheet method. The mixed raw material powder is granulated by spraying. The spray granulation may be carried out by, for example, spray drying in warm air of an inert gas such as nitrogen and argon containing little oxygen at approximately 60 to 200° C. The particle size of the granulated powder may be approximately 50 μm to 200 μm. A solvent or the like is added as necessary to adjust the content of liquid in the granulated powder, so that approximately 0.1 to 10 wt % of solvent is contained in the granulated material.

Primary Compacting

This granulated material is then filled in a predetermined mold and primarily compacted by a cold press to obtain a compact. Here, for example, the granulated material may be filled in a mold made of metal or carbon for forming a disc having an inner diameter of 150 mm, and cold-pressed with a pressure of approximately 5 to 15 MPa (50 to 150 kgf/cm²)

Hot Press

The compact prepared by primary compacting is hot-pressed to obtain a sintered body. Preferably, for example, the sintering temperature is 1200 to 1700° C., the pressure is 10 to 50 MPa (100 to 500 kgf/cm²), and the atmosphere is a vacuum, nitrogen or argon atmosphere. The purpose of making a non-oxidizing atmosphere is to prevent oxidization of TiC. A mold made of carbon is preferably used. The sintering time may be approximately 1 to 3 hours.

From the resulting sintered body, a member having a shape suitable for a spacer for a flat panel display is fabricated by mechanical processing.

The sheet method is advantageous in terms of a cost because mechanical processing after sintering is less extensive than that of the hot press method. The hot press method has an advantage that a denser sintered body can be obtained because a hot press is used in sintering.

### EXAMPLE 1

First, a specific example of fabricating a spacer by the sheet method will be described.

An Al₂O₃ powder (mean particle size: approximately 0.5 μm), a TiO₂ powder (mean particle size: approximately 1.7 μm) and a MgO powder (mean particle size: approximately 5.8 μm) were weighed to the composition shown in Table 1, and blended, and the powders were then milled and mixed by a wet process using a ball mill to obtain a raw material powder for slurry.

A binder, a dispersant, a plasticizer and a solvent were added to the raw material powder for slurry according to the details described below, and they were mixed by a ball mill to produce a slurry for forming a sheet.

binder: polyvinyl butyral resin . . . 3 wt %

dispersant: graft polymer anionic dispersant . . . 2 wt %

plasticizer: phthalate (e.g. BPBG) . . . 3 wt %

solvent: alcohol (e.g. ethanol) +aromatic compound (e.g. toluene) . . . 51.25 wt %

The slurry thus obtained was used to fabricate a green sheet having a thickness of approximately 150 μm by the doctor blade method, and the green sheet was cut to obtain a test wafer having a width of 56 mm and a length of 65 mm. For removing the contained binder, the wafer was subjected to binder removal in which the wafer was held at 400° C. for 8 hours in an atmosphere.

After binder removal, sintering was carried out by holding the wafer in a N₂ atmosphere at 1600° C. for 2 hours.

For the resulting sintered body, the resistivity and the three-point bending strength were measured under the following conditions. The results are shown in Table 1.

Resistivity:

An InGa electrode having a diameter of 5 mm was formed on each of the front and back surfaces of the sintered body, and a voltage of 10 kV/mm was then applied to measure the resistivity by the two-terminal method.

Three-Point Bending Strength:

The sintered body was cut into a width of 2.5 mm and a thickness of approximately 130 μm, and the three-point bending strength was measured based on JIS 1601. The distance between supporting points was 5 mm.

Using a sintered body of 0.5 mm×0.5 mm×10 mm prepared for measurement of the coefficient of thermal expansion, the coefficient of thermal expansion was measured at 50 to 400° C. The results are also shown in Table 1.

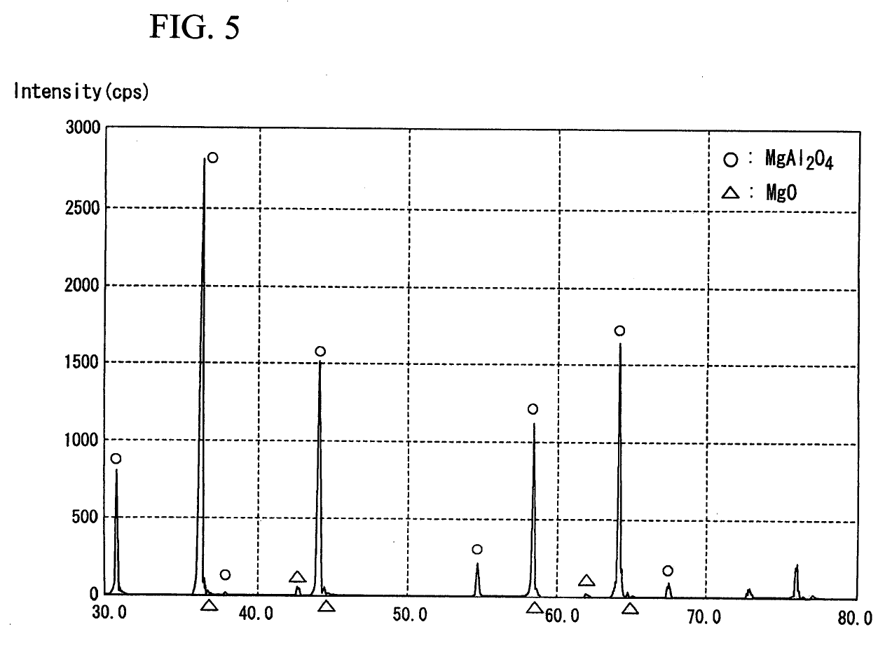

As shown in Table 1, the sintered bodies of No. 1 to 12 each contain MgAl₂O₄ and have MgAl₂O₄ as a main phase as a result of X-ray diffraction. The X-ray refraction chart (using a CuKα1 ray) of the sintered body of No. 2 is shown in FIG. 5, and two phases of MgAl₂O₄ and MgO are identified, but TiO₂ added at the time of blending could not be identified. It can be understood that TiO₂ could not be identified by X-ray diffraction because TiO₂ is solidly dissolved in MgAl₂O₄ from the fact that the resultant peak of MgAl₂O₄ is shifted to the low angle side compared to that of the pure spinel phase shown in JCPDS card 21-1152, and that the existence of Ti and O has been confirmed in observation by SEM-EDS. The same holds true for other sintered bodies.

As shown in Table 1, it is apparent that the sintered bodies of No. 1 to 12 having MgAl₂O₄ as a main phase have a coefficient of thermal expansion in the range of the coefficient of thermal expansion of a glass (8.0 to 9.3×10⁻⁶/° C.) or close to the coefficient of thermal expansion of a glass. In contrast to this, the sintered body of No. 13 having Al₂O₃ as a main phase has a coefficient of thermal expansion of 7.2−10⁻⁶/° C., which represents a large difference between its coefficient of thermal expansion and the coefficient of thermal expansion of a glass, and cannot practically be used as a spacer.

As shown in Table 1, the sintered bodies of No. 1 to No. 12 having MgAl₂O₄ as a main phase have a resistivity in the range of 1.0×10⁶ to 1.0×10¹¹Ω·cm. Thus, even if an electric field is applied, a desired conductivity is shown, electric charge is hard to occur, thermal runaway resulting from passage of an overcurrent is inhibited, and distortion of images in the flat panel display can be inhibited.

Further, as shown in Table 1, the sintered bodies of No. 1 to 12 having MgAl₂O₄ as a main phase have a three-point bending strength of 400 MPa or greater, and therefore can be resistant to deformation by a compressive force suing use of the flat panel display. In contrast to this, the sintered body of No. 13 has a three-point bending strength which is as low as 350 MPa.

TABLE 1

| | | | | | | | | | Coefficient of |
|---|---|---|---|---|---|---|---|---|---|
| | | | | | X-ray diffraction: peak strength ratio | | | | thermal |
| | Composition of mixture (wt %) | | | | MgAl₂O₄ | MgO | Al₂O₃ | Ti(C, N) | expansion |
| No. | MgO | Al₂O₃ | TiO₂ | TiC | (3 1 1) | (2 0 0) | (1 0 4) | (2 0 0) | [1/° C.] |
| 1 | 30.00 | 55.00 | 15.00 | 0.00 | 100 | 1.0 | 0 | 0 | 8.0 × 10⁻⁶ |
| 2 | 35.00 | 50.00 | 15.00 | 0.00 | 100 | 1.7 | 0 | 0 | 8.2 × 10⁻⁶ |
| 3 | 40.00 | 45.00 | 15.00 | 0.00 | 100 | 2.2 | 0 | 0 | 8.3 × 10⁻⁶ |
| 4 | 45.00 | 40.00 | 15.00 | 0.00 | 100 | 2.6 | 0 | 0 | 8.6 × 10⁻⁶ |
| 5 | 50.00 | 35.00 | 15.00 | 0.00 | 100 | 6.0 | 0 | 0 | 8.9 × 10⁻⁶ |
| 6 | 55.00 | 30.00 | 15.00 | 0.00 | 100 | 13.1 | 0 | 0 | 9.1 × 10⁻⁶ |
| 7 | 60.00 | 25.00 | 15.00 | 0.00 | 100 | 17.6 | 0 | 0 | 9.3 × 10⁻⁶ |
| 8 | 35.00 | 60.00 | 5.00 | 0.00 | 100 | 1.4 | 0 | 0 | 8.0 × 10⁻⁶ |
| 9 | 35.00 | 55.00 | 10.00 | 0.00 | 100 | 1.6 | 0 | 0 | 8.1 × 10⁻⁶ |
| 10 | 35.00 | 45.00 | 20.00 | 0.00 | 100 | 1.8 | 0 | 0 | 8.1 × 10⁻⁶ |
| 11 | 25.00 | 60.00 | 15.00 | 0.00 | 100 | 0.2 | 0 | 0 | 7.9 × 10⁻⁶ |
| 12 | 65.00 | 20.00 | 15.00 | 0.00 | 100 | 37.4 | 0 | 0 | 9.5 × 10⁻⁶ |
| 13 | 0.00 | 90.00 | 10.00 | 0.00 | 0 | 0 | 100 | 0 | 7.2 × 10⁻⁶ |

| | | |
|---|---|---|
| | Three-point | |
| | bending | |
| Resistivity | strength | Composition of sintered body(mol %) |

| No. | at 10 kV/mm | [MPa] | MgAl₂O₄ | MgO | Al₂O₃ | TiO₂ | TiC |
|---|---|---|---|---|---|---|---|
| 1 | 2.0 × 10⁸ | 400 | 57.88 | 21.97 | 0.00 | 20.15 | 0.00 |
| 2 | 1.0 × 10⁹ | 410 | 46.44 | 35.78 | 0.00 | 17.78 | 0.00 |
| 3 | 3.0 × 10⁹ | 410 | 37.40 | 46.69 | 0.00 | 15.91 | 0.00 |
| 4 | 5.0 × 10⁹ | 410 | 30.08 | 55.52 | 0.00 | 14.40 | 0.00 |
| 5 | 1.0 × 10¹⁰ | 420 | 24.04 | 62.82 | 0.00 | 13.15 | 0.00 |
| 6 | 1.0 × 10¹⁰ | 420 | 18.96 | 68.95 | 0.00 | 12.10 | 0.00 |
| 7 | 2.0 × 10¹⁰ | 420 | 14.63 | 74.17 | 0.00 | 11.20 | 0.00 |
| 8 | 1.0 × 10¹¹ | 410 | 63.22 | 30.06 | 0.00 | 6.72 | 0.00 |
| 9 | 1.0 × 10¹⁰ | 410 | 54.30 | 33.10 | 0.00 | 12.60 | 0.00 |
| 10 | 5.0 × 10⁷ | 410 | 39.45 | 38.16 | 0.00 | 22.38 | 0.00 |
| 11 | 4.0 × 10⁷ | 400 | 72.83 | 3.93 | 0.00 | 23.24 | 0.00 |
| 12 | 2.0 × 10¹⁰ | 420 | 10.90 | 78.67 | 0.00 | 10.43 | 0.00 |
| 13 | 5.0 × 10⁹ | 350 | 0.00 | 0.00 | 87.58 | 12.42 | 0.00 |

### EXAMPLE 2

An Al₂O₃powder (mean particle size: 0.5 μm, purity: 99.9%), a TiC powder (mean particle size: 0.5 μm, purity: 99%, the content of carbon is 19% or greater, of which 1% or less is represented by free graphite), a TiO₂ powder (mean particle size: 0.1 μm) and a MgO powder (mean particle size: 5.8 μm) were weighed to the composition shown in Table 2, and blended, and a sample was prepared in the same manner as in example 1, except that nitrogen moistened to a dew point of 35° C. was used in an atmosphere for binder removal.

For the resulting sintered body, the diffraction peak strength of a phase identified by X-ray diffraction was determined. For the resulting sintered body, the coefficient of thermal expansion, the resistivity and the three-point bending strength were measured under the same conditions as in Example 1. The results are shown in table 2.

TABLE 2

| | | | | | | | | | Coefficient of |
|---|---|---|---|---|---|---|---|---|---|
| | | | | | X-ray diffraction: peak strength ratio | | | | thermal |
| | Composition of mixture (wt %) | | | | MgAl₂O₄ | MgO | Al₂O₃ | Ti(C, N) | expansion |
| No. | MgO | Al₂O₃ | TiO₂ | TiC | (3 1 1) | (2 0 0) | (1 0 4) | (2 0 0) | [1/° C.] |
| 14 | 35.00 | 55.50 | 2.50 | 7.00 | 100 | 6.7 | 0 | 12.1 | 8.1 × 10⁻⁶ |
| 15 | 40.00 | 50.50 | 2.50 | 7.00 | 100 | 9.1 | 0 | 10.8 | 8.5 × 10⁻⁶ |
| 16 | 45.00 | 45.50 | 2.50 | 7.00 | 100 | 11.1 | 0 | 9.7 | 8.8 × 10⁻⁶ |
| 17 | 50.00 | 40.50 | 2.50 | 7.00 | 100 | 12.7 | 0 | 8.9 | 9.0 × 10⁻⁶ |
| 18 | 55.00 | 35.50 | 2.50 | 7.00 | 100 | 21.0 | 0 | 8.1 | 9.3 × 10⁻⁶ |
| 19 | 40.00 | 51.50 | 1.50 | 7.00 | 100 | 9.0 | 0 | 10.9 | 8.5 × 10⁻⁶ |
| 20 | 40.00 | 51.00 | 2.00 | 7.00 | 100 | 9.1 | 0 | 10.9 | 8.5 × 10⁻⁶ |
| 21 | 40.00 | 50.00 | 3.00 | 7.00 | 100 | 9.1 | 0 | 10.7 | 8.5 × 10⁻⁶ |
| 22 | 40.00 | 49.50 | 3.50 | 7.00 | 100 | 9.2 | 0 | 10.7 | 8.5 × 10⁻⁶ |
| 23 | 40.00 | 51.50 | 2.50 | 6.00 | 100 | 9.1 | 0 | 9.4 | 8.5 × 10⁻⁶ |
| 24 | 40.00 | 49.50 | 2.50 | 8.00 | 100 | 9.1 | 0 | 12.2 | 8.5 × 10⁻⁶ |
| 25 | 40.00 | 48.50 | 2.50 | 9.00 | 100 | 9.2 | 0 | 13.5 | 8.5 × 10⁻⁶ |
| 26 | 30.00 | 60.50 | 7.00 | 2.50 | 100 | 0.7 | 0 | 5.0 | 7.7 × 10⁻⁶ |
| 27 | 60.00 | 30.50 | 7.00 | 2.50 | 100 | 46.1 | 0 | 2.7 | 9.5 × 10⁻⁶ |

| | | |
|---|---|---|
| | Three-point | |
| | bending | |
| Resistivity | strength | Composition of sintered body(mol %) |

| No. | at 10 kV/mm | [MPa] | MgAl₂O₄ | MgO | Al₂O₃ | TiO₂ | TiC |
|---|---|---|---|---|---|---|---|
| 14 | 1.0 × 10⁶ | 450 | 53.55 | 31.87 | 0.00 | 3.08 | 11.50 |
| 15 | 1.0 × 10⁹ | 450 | 43.43 | 43.58 | 0.00 | 2.74 | 10.25 |
| 16 | 1.0 × 10⁹ | 450 | 35.29 | 52.99 | 0.00 | 2.47 | 9.24 |
| 17 | 1.0 × 10⁹ | 450 | 28.61 | 60.72 | 0.00 | 2.25 | 8.42 |
| 18 | 1.0 × 10⁹ | 450 | 23.02 | 67.19 | 0.00 | 2.07 | 7.73 |
| 19 | 1.0 × 1011 | 450 | 44.78 | 43.19 | 0.00 | 1.66 | 10.36 |
| 20 | 5.0 × 10¹⁰ | 450 | 44.10 | 43.39 | 0.00 | 2.21 | 10.30 |
| 21 | 5.0 × 10⁷ | 450 | 42.76 | 43.77 | 0.00 | 3.28 | 10.19 |
| 22 | 1.0 × 106 | 450 | 42.11 | 43.96 | 0.00 | 3.80 | 10.14 |
| 23 | 1.0 × 10⁹ | 420 | 44.95 | 43.35 | 0.00 | 2.78 | 8.91 |
| 24 | 1.0 × 10⁹ | 450 | 41.95 | 43.80 | 0.00 | 2.70 | 11.54 |
| 25 | 1.0 × 10⁹ | 420 | 40.52 | 44.01 | 0.00 | 2.67 | 12.80 |
| 26 | 1.0 × 10⁹ | 400 | 67.92 | 17.27 | 0.00 | 10.03 | 4.78 |
| 27 | 1.0 × 10⁹ | 450 | 18.49 | 73.51 | 0.00 | 5.42 | 2.58 |

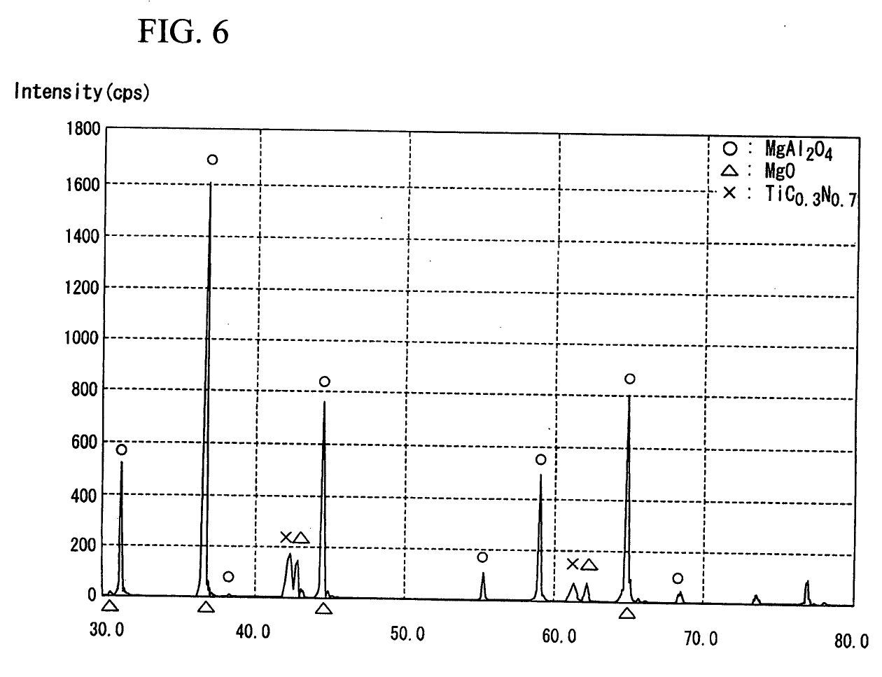

As shown in Table 2, the sintered bodies of No. 14 to 27 each contain MgAl₂O₄ and have MgAl₂O₄ as a main phase as a result of X-ray diffraction. The X-ray detraction chart (using a CuKα1 ray) of the sintered body of No. 15 is shown in FIG. 6, and three phases of MgAl₂O₄, MgO and TiC_{0.3}N_{0.7} are identified. For TiC_{0.3}N_{0.7}, the added TiC was changed into TiC_{0.3}N_{0.7} in a sintering process in a nitrogen atmosphere. TiO₂ added at the time of blending could not be identified for reasons that are same as those in example 1.

As shown in Table 2, it is apparent that the sintered bodies of No. 14 to 27 having MgAl₂O₄ as a main phase have a coefficient of thermal expansion in the range of the coefficient of thermal expansion of a glass (8.0 to 9.3×10⁻⁶/° C.) or close to the coefficient of thermal expansion of a glass.

As shown in Table 2, the sintered bodies of No. 14 to No. 27 having MgAl₂O₄ as a main phase have a resistivity in the range of 1.0×10⁶ to 1.0×10¹¹Ω·cm. Thus, even if an electric field is applied, a desired conductivity is shown, electric charge is hard to occur, thermal runaway resulting from passage of an overcurrent is inhibited, and distortion of images in the flat panel display can be inhibited.

Further, as shown in Table 2, the sintered bodies having MgAl₂O₄ as a main phase have a three-point bending strength of 400 MPa or greater, and therefore can be resistant to deformation by a compressive force suing use of the flat panel display.

### EXAMPLE 3

A sample was prepared in the same manner as in example 1, except that an Al₂O₃ powder (mean particle size: approximately 0.5 μm), a TiO₂ powder (mean particle size: approximately 1.7 μm), a MgO powder (mean particle size: approximately 5.8 μm) and a Cr₂O₃ powder (mean particle size: approximately 3.0 μm) were weighed and added at a composition ratio shown in Table 3, and the coefficient of thermal expansion, the resistivity and the three-point bending strength were measured under the same conditions as in Example 1. A scanning electron microscope (SEM) was used to observe the state of the surface of the resulting sample. A SEM image was photographed with each sintered body sample electrically isolated from a sample mount so that electric charges escaped from the sintered body sample. The results are shown in Table 3.

TABLE 3

| | | | | | Coefficient | | Three-point | |
|---|---|---|---|---|---|---|---|---|
| | | | | | of thermal | | bending | |
| | Composition of mixture(wt %) | | | | expansion | Resistivity | strength | SEM contrast |
| No. | MgO | Al₂O₃ | TiO₂ | Cr₂O₃ | [1/° C.] | at 5 kV/mm | [MPa] | (brightness) |
| 28 | 47.00 | 39.00 | 14.00 | 0.00 | 8.7 × 10⁻⁶ | 5.0 × 10⁹ | 450 | very bright |
| 29 | 47.50 | 35.50 | 15.50 | 1.50 | 8.6 × 10⁻⁶ | 3.0 × 10⁹ | 450 | bright |
| 30 | 46.50 | 34.50 | 15.00 | 4.00 | 8.4 × 10⁻⁶ | 1.0 × 10⁹ | 450 | dark |
| 31 | 45.00 | 33.50 | 14.50 | 7.00 | 8.4 × 10⁻⁶ | 1.0 × 10⁹ | 450 | dark |
| 32 | 41.00 | 30.50 | 13.50 | 15.00 | 8.4 × 10⁻⁶ | 1.0 × 10⁹ | 420 | dark |
| 33 | 39.50 | 29.50 | 13.00 | 18.00 | 8.3 × 10⁻⁶ | 0.8 × 10⁸ | 350 | dark |

As shown in Table 3, it is apparent that the sintered bodies of No. 29 to 33 with Cr added have a coefficient of thermal expansion falling within the range of the coefficient of thermal expansion of glass of 8.0 to 9.3×10⁻⁶/° C. as in the case of the sintered body of No. 28 with no Cr added.

However, when the amount of Cr₂O₃ added is 18.00 wt % (No. 33), the three-point bending strength is as low as 350 MPa, and therefore it can be considered that the strength becomes insufficient if the amount of Cr₂O₃ added exceeds 15 wt %.

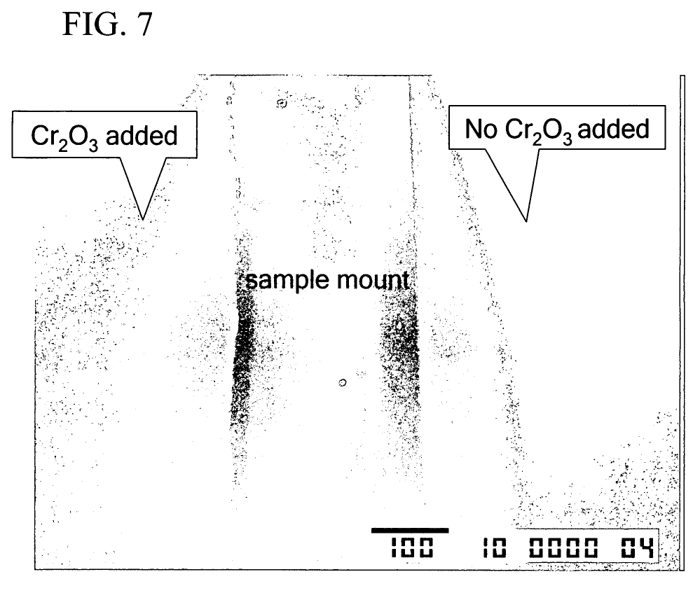

The SEM contrast brightness is improved by addition of Cr, but when the amount of Cr₂O₃ added is 1.50 wt % (No. 29), the improvement effect is low. Accordingly, for obtaining the effect of improvement of the SEM contrast, the amount of Cr₂O₃ added is preferably 4 wt % or greater. SEM images of the sample No. 28 (with no Cr added) and the sample No. 31 (with Cr added) are shown in FIG. 7. From FIG. 7, it is apparent that the SEM image of the sample No. 31 is generally darker, and the SEM image of the sample No. 28 has larger white areas. Since the SEM contrast becomes brighter as the amount of emission of secondary electrons increases, it can be said that the amount of emission of secondary electrons is reduced by addition of Cr.

From the results described above, it could be confirmed that the preferable amount of Cr₂O₃ added is 4 to 15 wt %.

### EXAMPLE 4

A specific example of fabricating a spacer by the hot press method will now be described.

An Al₂O₃powder (mean particle size: 0.5μm, purity: 99.9%), a TiC powder (mean particle size: 0.5 μm, purity: 99%, the content of carbon is 19% or greater, of which 1% or less is represented by free graphite), a TiO₂ powder (mean particle size: 0.1 μm) and a MgO powder (mean particle size: 5.8 μm) were weighed to the composition shown in sample No. 15 in Table 2, and blended, and the powders were milled and mixed together with ethanol in a ball mill for 30 minutes, and granulated by spraying in nitrogen at 150° C. to obtain a granulated material.

Subsequently, the resulting granulated material was primarily compacted at approximately 0.5 MPa (50 kgf/cm²), and the resulting compact was sintered by the hot press method in a vacuum atmosphere for 1 hour at a sintering temperature of 1600° C. and under a press pressure of 30 MPa (300 kgf/cm²).

For the resulting sintered body, the diffraction peak strength of a phase identified by X-ray diffraction was determined. For the resulting sintered body, the coefficient of thermal expansion, the resistivity and the three-point bending strength were measured in the same manner as in example 1. The results are shown below.

Peak strength ratio: MgAl₂O₄ (311)=100, MgO (200)=33, Al₂O₃ (104)=0, TiC (200)=48

Coefficient of thermal expansion: 8.5×10⁻⁶/° C.

Resistivity: 1×10⁹ Ω·cm

Three-point bending strength: 480 MPa

What is claimed is:

1. A spacer for a flat panel display comprising a sintered body containing MgAl₂O₄.

2. The spacer for a flat panel display according to claim 1, wherein MgAl₂O₄ is a main phase of said sintered body.

3. The spacer for a flat panel display according to claim 1, wherein said sintered body further contains MgO.

4. The spacer for a flat panel display according to claim 3, wherein said sintered body contains MgAl₂O₄ and MgO, and a peak strength on the MgO (200) plane is 0.2 to 50 when a peak strength on the MgAl₂O₄ (311) plane is 100 as measured by X-ray diffraction.

5. The spacer for a flat panel display according to claim 3, wherein said sintered body contains MgAl₂O₄ and MgO, and the peak strength on the MgO (200) plane is 0.8 to 30 when the peak strength on the MgAl₂O₄ (311) plane is 100 as measured by X-ray diffraction.

6. The spacer for a flat panel display according to claim 1, wherein said sintered body further contains a conductive compound.

7. The spacer for a flat panel display according to claim 6, wherein said conductive compound is a titanium compound.

8. The spacer for a flat panel display according to claim 7, wherein said titanium compound is at least one of carbides, nitrides, oxides and carbonitrides of Ti.

9. The spacer for a flat panel display according to claim 8, wherein said titanium compound is TiO₂ or/and TiC.

10. The spacer for a flat panel display according to claim 9, wherein said titanium compound is TiO₂.

11. The spacer for a flat panel display according to claim 1, wherein said sintered body has a coefficient of thermal expansion of 7.7 to 9.6×10⁻⁶/° C.

12. A flat panel display comprising:
a back plate having a cathode structure;
a face plate placed with a predetermined spacing between itself and said back plate and having fluorescent pixel areas; and
a spacer placed between said back plate and said face plate and holding said spacing,
wherein said spacer comprises a sintered body containing MgAl₂O₄.

13. The flat panel display according to claim 12, wherein MgAl₂O₄ is a main phase of said sintered body, and said sintered body further contains MgO.

14. The flat panel display according to claim 13, wherein said sintered body contains MgAl₂O₄ and MgO, and a peak strength on the MgO (200) plane is 0.2 to 50 when a peak strength on the MgAl₂O₄ (311) plane is 100 as measured by X-ray diffraction.

15. The flat panel display according to claim 13 or 14, wherein said sintered body further contains TiO₂ and/or TiC as a conductive compound.

16. The flat panel display according to claim 12, wherein said sintered body has a coefficient of thermal expansion of 7.7 to 9.6×10⁻⁶/° C.

17. The flat panel display according to claim 12, wherein said face plate is composed of a glass having a coefficient of thermal expansion of 8.0 to 9.3×10⁻⁶/° C., and the coefficient of thermal expansion of said sintered body is 8.0 to 9.3×10⁻⁶/° C.

18. The flat panel display according to claim 12, wherein said back plate is composed of a glass having a coefficient of thermal expansion of 8.0 to 9.3×10⁻⁶/° C., and the coefficcient of thermal expansion of said sintered body is 8.0 to 9.3×10⁻⁶/° C.

19. The flat panel display according to claim 12, wherein said sintered body has a three-point bending strength of 400 to 500 MPa.

20. The flat panel display according to claim 12, wherein said flat panel display is a field emission display.
